(19) United States
(12) Patent Application Publication
(10) Pub. No.: US 2020/0170245 A1
(43) Pub. Date: Jun. 4, 2020

(54) SYNERGISTIC COMBINED TREATMENT FOR PLANT, INSECT, AND RODENT-VERMIN PESTS SYSTEM AND METHOD

(71) Applicant: Dustin Cheramie, Galiano, LA (US)

(72) Inventor: Dustin Cheramie, Galiano, LA (US)

(21) Appl. No.: 16/209,725

(22) Filed: Dec. 4, 2018

(51) Int. Cl. A01N 25/02; A01N 57/20; A01N 59/00; A01N 45/00; A01N 25/22

(52) U.S. Cl. CPC A01N 25/02; A01N 57/20; A01N 25/22; A01N 45/00; A01N 59/00

(57) ABSTRACT

A synergistic combined treatment for plant, insect, and rodent-vermin pests system and method addressing the combination problem of overproliferating plants harboring blood-feeding insects, rodents, and other vermin animals, providing a pest-control combination solution comprising a stabilized glyphosate solution, a sequestered manganese solution, a stabilized progestin solution, and a carrier solution, applied as a spray, where, after application, the various components and the breakdown products of the various components increase the efficacy and promote the safe breakdown in the environment of the other components.

### BACKGROUND OF THE INVENTION

This invention provides a synergistic combined treatment for plant, insect, and rodent-vermin pests system and method.

In certain warm, wet climates, the problem of overproliferation of plants correlates with problems regarding blood-feeding insects, such as mosquitoes and fleas, and rodents and other vermin animals, such as rats and mice. The overproliferated plants hold stagnant water favorable to the proliferation of insects, and also provide cover for rodents and vermin.

Mosquitoes are a large health problem. Human deaths resulting from parasite and virus infection transmitted by mosquitoes far exceeds death caused by any other animal. Rodents and other vermin carry disease and pestilence. The combination of disease-carrying rodents and vermin with blood-feeding insects acting as vectors accounts for a significant amount of disease and pestilence among human populations.

Overproliferation of plants can be effectively treated with glyphosate, but normally, glyphosate only partially degrades in the soil to aminomethylphosphonic acid (AMPA) which does not normally degrade further because soils normally lack the manganese oxide needed for further degradation. Normally, this further degradation is performed by microbes, which have mitochondria, which in turn have manganese, and therefore the microbes can use and break down the AMPA. However, the glyphosate and AMPA are toxic to many microbes. See Elisabeth A. Scribner, William A. Battaglin, Robert J. Gilliom, & Michael T. Meyer, Concentrations of Glyphosate, Its Degradation Product, Aminomethylphosphonic Acid, and Glufosinate in Ground- and Surface-Water, Rainfall, and Soil Samples Collected in the United States, 2001-06, in U.S. Geological Survey Scientific Investigations Report 2007-5122, p. 111 (USGS, 2007); Jeff Schuette, Environmental Fate of Glyphosate, in Environmental Monitoring & Pest Management, Department of Pesticide Regulation (revised November 1998); K. Barret & M. McBride, Oxidative Degradation of Glyphosate and Aminomethylphosphonate by Manganese Oxide., in 39 Environ. Sci. Technol., pp 9223-9228 (Cornell Univ., 2005); G. Forlani, A. Mangiagalli, E. Nielsen, & C. M. Suardi, Degradation of the Phosphonate Herbicide Glyphosate in Soil: Evidence for a Possible Involvement of Unculturable Microorganisms, in Soil Biology and Biochemistry, pp. 991-997 (1999); and William Abraham, U.S. Pat. No. 7,771,736, GLYPHOSATE FORMULATIONS AND THEIR USE FOR INHIBITION OF 5-ENOLPYROVYLSHIKIMATE-3-PHOSPHATE SYNTHASE (2010).

Glyphosate is a chemical chelator which binds and removes minerals such as calcium, magnesium, manganese, copper, and zinc. See Arthur Dock Fon Toy et al., U.S. Pat. No. 3,160,632, AMENOMETHYLENEPHOSPHINIC ACIDS, SALTS THEREOF, AND PROCESS FOR THEIR PRODUCTION (1964).

The control of mosquitoes with pesticides comes with the problem that the pesticides can have undesirable effects on plants, other animals, and humans. With mosquitoes, sterilization with radiation seems to lessen the ability of the sterilized males to mate, making this method less effective in mosquitoes than in other species. Using poisons to control rats living amongst vegetation comes with problems of the poisons affecting unintended species, even humans.

Insects and rodents are eukaryotic organisms, composed of cells having a nucleus and having mitochondria. The mitochondria are considered the powerhouse of the cell because mitochondria are where the citric acid cycle or Krebs cycle takes place, converting adenosine diphosphate (ADP) to adenosine triphosphate (ATP) and back. See Neil A. Campbell, Brad Williamson, & Robin J. Heyden, Biology: Exploring Life (Pearson Prentice Hall 2006).

This conversion between ADP and ATP is done by the ATP synthase enzyme. The formation of ATP from ADP and inorganic phosphate is energetically unfavorable, and therefore requires coupling to an electrochemical gradient resulting from a difference in proton concentration across the mitochondrial membrane, in turn resulting from an electron transport chain (ETC) process. The ETC generates reactive oxygen species (ROS) also called superoxide radicals or free radicals, which cause great damage and harm to the mitochondria and the cell unless the ROS are neutralized. Such neutralization is performed by two enzymes expressed from the corpus luteum, which scavenge superoxide radicals and protect cells from their toxic activities: cytosolic copper, zinc-superoxide dismutase (Cu,Zn-SOD) and mitochondrial manganese-superoxide dismutase (Mn-SOD). See W. Junge & N. Nelson, ATP Synthase, in Annual Rev. Biochem, pp. 631-57 (2015); and Christoph Richter, Jeen-Woo Park, & Bruce N. Ames, Normal Oxidative Damage to Mitochondrial and Nuclear DNA is Extensive, in Proc. Natl. Acad. Sci. USA, pp. 6465-6467 (September 1988).

The hormone estrogen has been found to provide health benefits by improving and increasing the neutralization of the ROS superoxide radicals by Mn-SOD. See Carolyn M. Klinge, Estrogenic Control of Mitochondrial Function and Biogenesis, in J Cell Biochem. (Univ. of Louisville School of Med., December 2008); James W. Simpkins, ShaoHua Yang, Saumyendra N. Sarkar, & Virginia Pearce, Estrogen Actions on Mitochondria-Physiological and Pathological Implications, in. Mol Cell Endocrinol. (Univ. of N. Texas Health Science Center, August 2008); Michelle Pine, Boyeon Lee, Robert Dearth, Jill K. Hiney, & W. Les Dees, Manganese Acts Centrally to Stimulate Luteinizing Hormone Secretion: A Potential Influence on Female Pubertal Development, in Toxicological Sciences, pp. 880-85 (Texas A&M Univ., June 2005); and Norihiro Sugino, Mitsuko Hirosawa-Takamori, Liping Zhong, Carlos M. Telleria, Kunio Shiota, & Geula Gibori, Hormonal Regulation of Copper-Zinc Superoxide Dismutase and Manganese Superoxide Dismutase Messenger Ribonucleic Acid in the Rat Corpus Luteum: induction by Prolactin and Placental Lactogens, in Biology of Reproduction, pp. 599-605 (Univ. of Illinois at Chicago, 1998).

The hormone progesterone has functional antiestrogenic effects due to its progestogenic activity. Progesterone is also a potent antimineralocorticoid, or antagonist of the mineralocorticoid receptor, the biological target of the mineralocorticoid aldosterone. Such interference with aldosterone produces the negative effects of adrenal gland failure such as low blood pressure and electrolyte imbalance. See H. Kuhl, Pharmacology of Estrogens and Progestogens: Influence of Different Routes of Administration, in Climacteric, pp. 3-63 (Goethe Univ. of Frankfurt, Germany, 2005).

Excessive manganese (Mn) exposure is toxic. Chronic manganese exposure rewires diverse regulatory and metabolic pathways. Manganese stress affects protein and other macromolecular stability, and envelope biogenesis. Manganese exposure reduces energy metabolism by disrupting both iron-sulfur cluster and heme-enzyme biogenesis by depleting cellular iron level. The compromised function of the iron-dependent enzymes in the tricarboxylic acid cycle and electron transport chain (ETC) impede ATP synthesis, leading to severe energy deficiency. Manganese stress also evokes reactive oxygen species (ROS) inducing oxidative stress and depressing oxidative phosphorylation and cell growth. See Gursharan Kaur, Vineet Kumar, Amit Arora, Ajay Tomar, Ashish, Runa Sur, & Dipak Dutta, Affected Energy Metabolism Under Manganese Stress Governs Cellular Toxicity, in Scientific Reports (2017).

What is needed is a system and method for eliminating the combined plant, insect, and rodent-vermin pests with a combination of substances which will be toxic to the pests, but will quickly denature, neutralize, or otherwise break down the other substances, leaving no toxic or deleterious substances in the environment.

### SUMMARY OF THE INVENTION

This invention provides a synergistic combined treatment for plant, insect, and rodent-vermin pests system and method addressing the combination problem of overproliferating plants harboring blood-feeding insects, rodents, and other vermin animals, providing a pest-control combination solution comprising a stabilized glypho sate solution, a sequestered manganese solution, a stabilized progestin solution, and a carrier solution, applied as a spray, where, after application, the various components and the breakdown products of the various components increase the efficacy and promote the safe breakdown in the environment of the other components.

### BRIEF DESCRIPTION OF THE DRAWINGS

Reference will now be made to the drawings, wherein like parts are designated by like numerals, and wherein:

FIG. 1 is a schematic view of the use of the synergistic combined treatment for plant, insect, and rodent-vermin pests of the invention; and

FIG. 2 is a schematic view of the composition of the synergistic combined treatment for plant, insect, and rodent-vermin pests of the invention.

### DETAILED DESCRIPTION OF THE INVENTION

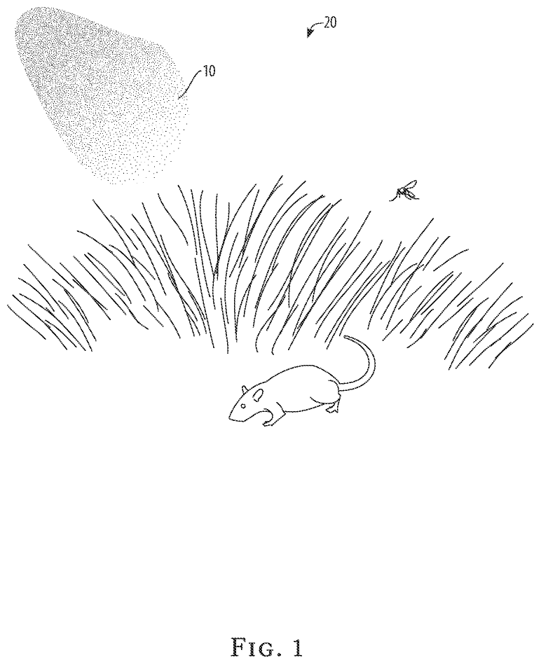

Referring to FIG. 1, use of the synergistic combined treatment for plant, insect, and rodent-vermin pests 20 system and method of the invention is shown schematically. A pest-control combination solution 10 is applied to an area infested with overproliferating plant pests, blood-feeding insect pests, and rodent-vermin pests.

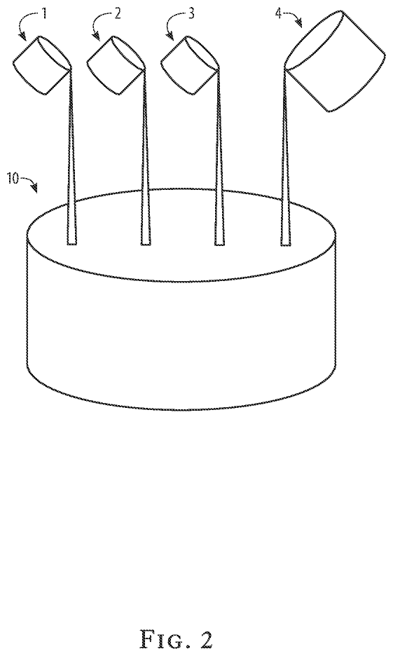

Referring to FIG. 2, the pest-control combination solution 10 provides a stabilized glyphosate solution 1, a sequestered manganese solution 2, a stabilized progestin solution 3, and a carrier solution 4, and is of liquid form capable of being applied by spraying of a liquid or aerosol. The pest-control combination solution 10 can be formulated as a concentrate to which water can be added at or near the time of application, or as a ready-to-use liquid or aerosol product. The pest-control combination solution 10 provides for preservation of the viability and activity of the separate components as a mixed solution during manufacture and storage.

The pest-control combination solution 10 provides a stabilized glyphosate solution 1. The main deactivation path for glyphosate starts with hydrolysis to aminomethylphosphonic acid (AMPA). The glyphosate, while in the pest-control combination solution 10, should be stabilized against hydrolysis. During airtight storage and handling, the glyphosate should not be subject to hydrolysis by the other components, manganese and progestin, by any direct action. But the formulation of the carrier solution 4, treated below, will likely contain water, because a liquid or aerosol spray application is desired, and, if not allowed for and countered by other substances, the carrier solution could tend to hydrolyse and denature the glyphosate solution 1. Also, in choosing ways to sequester manganese and stabilize progestin, treated below, care should be taken to avoid introducing anything which would tend to hydrolyse the glyphosate.

The pest-control combination solution 10 also provides a sequestered manganese solution 2. Encapsulation prevents the manganese (Mn) from forming manganese oxide, which would break down the glyphosate. The carrier solution 4, treated below, can be formulated to prevent oxidation of the manganese while in the pest-control combination solution 10. Glyphosate is a chelating agent or sequestering agent of manganese. Therefore, the glyphosate solution 1 can be formulated to use all, or a portion, of the glyphosate to chelate or sequester the manganese while in the pest-control combination solution 10. Alternatively, ethylenediaminetetraacetic acid (EDTA) or similar compounds can be used to sequester the manganese while in the pest-control combination solution 10, and subsequently release the manganese upon degradation of the EDTA.

The pest-control combination solution 10 also provides a stabilized progestin solution 3. The natural hormone is progestogen. Progestins are synthetic progestogens used in medicine. Medroxyprogesterone acetate, having chemical name 17α-Acetoxy-6α-methylprogesterone, is a widely used progestin and is suitable for use in the pest-control combination solution 10. The progestins are steroids, and the molecules have a steroid ring system important to their function. In the pest-control combination solution 10, it is important to stabilize the progestin molecules against any denaturing or changing caused by the other components. There are two aspects to this stabilization: rendering the other components incapable of attacking the progestin when in solution, and buffering or otherwise isolating the progestin molecules from attack. The sequestered manganese solution 2, which can involve chelation by the glyphosate solution 1, can operate to lessen any tendency to attack the progestin molecules, and the carrier solution, treated below, can provide buffering and isolation of the progestin molecules.

The pest-control combination solution 10 also provides a carrier solution 4, which protects against any component of the solution attacking another component, protects against spoilage of the solution during storage and handling, and provides a delivery vehicle appropriate for aerosol spraying with existing equipment. A preferred embodiment of the carrier solution 4 provides polyethelene glycol 3350, polysorbate 80, sodium chloride, methylparaben, propylparaben, and water.

In use, the pest-control combination solution 10 prevents denaturing or breaking down of the constituent substances during storage and handling, as treated above. The pest-control combination solution 10 is used by applying, as an aerosol or liquid spray, to the unwanted pest plants. Upon application, the glyphosate solution 1 component will act to kill the plants in the known way, and the glyphosate will start breaking down to aminomethylphosphonic acid (AMPA) by hydrolysis. The sequestered manganese solution 2 will release the manganese during the breakdown of the encapsulating, chelating, or sequestering agent, and some will oxidize to manganese oxide. The manganese oxide will act to further break down the AMPA so that no glyphosate residue is left in the soil. The released manganese will also be taken up by the insect and rodent-vermin pests, and this manganese will interfere with the mitochondrial respiration and energy-producing functions by the known mechanisms of manganese stress, which include an increase of ROS superoxide radicals and failure of ATP production. The manganese stress will kill the mosquitoes outright and will sicken the rodent vermin of both genders.

In use, after application, the stabilized progestin solution 3 will be taken in by the rodent vermin and will disrupt the reproductive systems of the adult females and depress the activity of Mn-SOD, leading to an increase in ROS superoxide radicals. The progestin will also affect adult and juvenile rodents of both genders as an antimineralocorticoid, causing adrenal gland failure, low blood pressure, and electrolyte imbalance.

Progestins in the environment do not cause the feminization problems seen with estrogens. Any progestins remaining after application and operation of the pest-control combination solution 10 are likely to be quickly broken down to benign substances.

Many other changes and modifications can be made in the system and method of the present invention without departing from the spirit thereof. I therefore pray that my rights to the present invention be limited only by the scope of the appended claims.

I claim:

1.-10. (canceled)

11. A synergistic combined treatment for plant, insect, and rodent-vermin pests method for addressing the combination problem of overproliferating plants harboring blood-feeding insects, rodents, and other vermin animals, the synergistic combined treatment for plant, insect, and rodent-vermin pests method comprising:
(i) providing a pest-control combination solution adapted to being applied as a spray, comprising:
(a) a stabilized glyphosate solution adapted to, after application, kill the plants and break down by hydrolysis into aminomethylphosphonic acid;
(b) a sequestered manganese solution adapted to, after application, become manganese oxide which breaks down aminomethylphosphonic acid further, and to supply an elevated level of manganese in the environment of the insects and rodent-vermin;
(c) a stabilized progestin solution adapted to, after application, supply an elevated level of progestin in the environment of the rodent-vermin; and
(d) a carrier solution adapted to stabilize said pest-control combination solution before application, and to facilitate application by spraying;
(ii) preventing, before application, said components of said pest-control combination solution from breaking down and from reacting one with another;
(iii) applying said pest-control combination solution by spraying;
(iv) allowing, after application, said components of said pest-control combination solution to break down and to react one with another; and
(v) leaving, after application and breaking down, no deleterious substances in the environment.

12. The synergistic combined treatment for plant, insect, and rodent-vermin pests method of claim 1, where said stabilized glyphosate solution is used to chelate said sequestered manganese solution.

13. The synergistic combined treatment for plant, insect, and rodent-vermin pests method of claim 1, where said carrier solution is used to stabilize said stabilized glyphosate solution.

14. The synergistic combined treatment for plant, insect, and rodent-vermin pests method of claim 1, where said carrier solution is used to stabilize said stabilized progestin solution.

15. The synergistic combined treatment for plant, insect, and rodent-vermin pests method of claim 1, where said carrier solution is used to sequester said sequestered manganese solution.

16. The synergistic combined treatment for plant, insect, and rodent-vermin pests method of claim 1, where said stabilized progestin solution further comprises medroxyprogesterone acetate.

17. The synergistic combined treatment for plant, insect, and rodent-vermin pests method of claim 1, where said pest-control combination solution further comprises EDTA.

18. The synergistic combined treatment for plant, insect, and rodent-vermin pests method of claim 1, where said carrier solution further comprises polyethelene glycol.

19. The synergistic combined treatment for plant, insect, and rodent-vermin pests method of claim 1, where said carrier solution further comprises a paraben.

20. The synergistic combined treatment for plant, insect, and rodent-vermin pests method of claim 1, where said carrier solution further comprises polyethelene glycol, polysorbate 80, sodium chloride, methylparaben, propylparaben, and water.
